(19) United States
(12) Patent Application Publication
(10) Pub. No.: US 2024/0253425 A1
(43) Pub. Date: Aug. 1, 2024

(54) VEHICLE FRAGRANCE SUPPLY DEVICE

(71) Applicant: TOYOTA JIDOSHA KABUSHIKI KAISHA, Toyota-shi (JP)

(72) Inventor: Ryuji OTSUKA, Toyota-shi (JP)

(21) Appl. No.: 18/530,217

(22) Filed: Dec. 6, 2023

(30) Foreign Application Priority Data
Jan. 31, 2023 (JP) 2023-013599

(51) Int. Cl. B60H 3/00

(52) U.S. Cl. CPC B60H 3/0071

(57) ABSTRACT

A vehicle fragrance supply device includes: a fragrance generator configured to generate a fragrance; a fragrance supply pipe configured to supply a generated scent from the fragrance generator to a vehicle cabin interior; and an ion supply pipe connected to the fragrance supply pipe, through which ions generated at an ion generator flow.

### CROSS-REFERENCE TO RELATED APPLICATION

This application claims priority under 35 USC 119 from Japanese Patent Application No. 2023-13599, filed Jan. 31, 2023, the disclosure of which is incorporated by reference herein in its entirety.

### BACKGROUND

### Technical Field

The present disclosure relates to a vehicle fragrance supply device.

### Related Art

Japanese Patent Application Laid-open (JP-A) No. 2019-38385 discloses a fragrance generating device including a cartridge filled with different fragrances.

In the fragrance generating device described in the above publication, perfume loaded in the cartridges is discharged into the vehicle cabin by blowing air from a blower. Moreover, it is described that vanilla-based perfumes are released during heating, and mint-based perfumes are released during cooling.

### SUMMARY

However, even in cases in which the fragrance generating device is stopped, fragrance may remain in a supply pipe or the like, and there is room for improvement from the standpoint of suppressing the generation of residual aroma.

The present disclosure provides a vehicle fragrance supply device capable of suppressing the generation of residual aroma.

A vehicle fragrance supply device of a first aspect of the present disclosure includes: a fragrance generator configured to generate a fragrance; a fragrance supply pipe configured to supply a generated scent from the fragrance generator to a vehicle cabin interior; and an ion supply pipe connected to the fragrance supply pipe, through which ions generated at an ion generator flow.

In the vehicle fragrance supply device of the first aspect, a scent generated from a fragrance generator that generates fragrance flows through a fragrance supply pipe and is supplied into the vehicle cabin. Moreover, an ion supply pipe, through which ions generated from an ion generator flow, is connected to the fragrance supply pipe. As a result, by actuating the ion generator, ions flow through the ion supply pipe to the fragrance supply pipe, and residual aroma remaining in the fragrance supply pipe is removed.

A vehicle fragrance supply device of a second aspect of the present disclosure is the first aspect, in which a blowing device is provided at the fragrance supply pipe, and the ion supply pipe is connected to the fragrance supply pipe between the blowing device and the fragrance generator.

In the vehicle fragrance supply device of the second aspect, an ion supply pipe is connected between a blowing device and a fragrance generator at the fragrance supply pipe. This enables the blowing device to be used jointly by the fragrance generator and the ion generator, which eliminates the need to provide a blowing device for supplying ions into the vehicle cabin.

A vehicle fragrance supply device of a third aspect of the present disclosure is the first aspect, in which plural fragrance generators are provided, and the vehicle fragrance supply device further includes a switch valve that is switchable between a state in which one of the fragrance generators is communicated with the fragrance supply pipe, and a state in which another of the fragrance generators is communicated with the fragrance supply pipe.

In the vehicle fragrance supply device of the third aspect, by controlling the switch valve, a scent generated by any given fragrance generator of the plural fragrance generators can be supplied into the vehicle cabin.

A vehicle fragrance supply device of a fourth aspect of the present disclosure is the third aspect, in which the ion supply pipe is connected to the switch valve, and the switch valve is switchable to a state in which the ion supply pipe is communicated with the fragrance supply pipe.

In the vehicle fragrance supply device of the fourth aspect, by controlling the switch valve, ions can be made to flow into the fragrance supply pipe. Moreover, by using the switch valve in a similar manner to the switching of the fragrance generators, the number of components can be reduced.

A vehicle fragrance supply device of a fifth aspect of the present disclosure is the first aspect, in which a blowing device is provided at the fragrance supply pipe, and the ion supply pipe is connected to the fragrance supply pipe at a downstream side of the blowing device.

In the vehicle fragrance supply device of the fifth aspect, an ion supply pipe is connected downstream of a blowing device in the fragrance supply pipe. This enables the ion generator and the ion supply pipe to be easily retrofitted to a device including the fragrance generator, the fragrance supply pipe, and the blowing device.

As described above, the vehicle fragrance supply device according to the present disclosure enables the generation of residual aroma to be suppressed.

### BRIEF DESCRIPTION OF THE DRAWINGS

FIG. 1 is a block diagram illustrating a hardware configuration of a vehicle fragrance supply device according to an exemplary embodiment;

FIG. 2 is a schematic diagram of a vehicle fragrance supply device according to an exemplary embodiment;

FIG. 3 is a schematic diagram of a vehicle fragrance supply device according to a first modified example; and

FIG. 4 is a schematic diagram of a vehicle fragrance supply device according to a second modified example.

### DETAILED DESCRIPTION

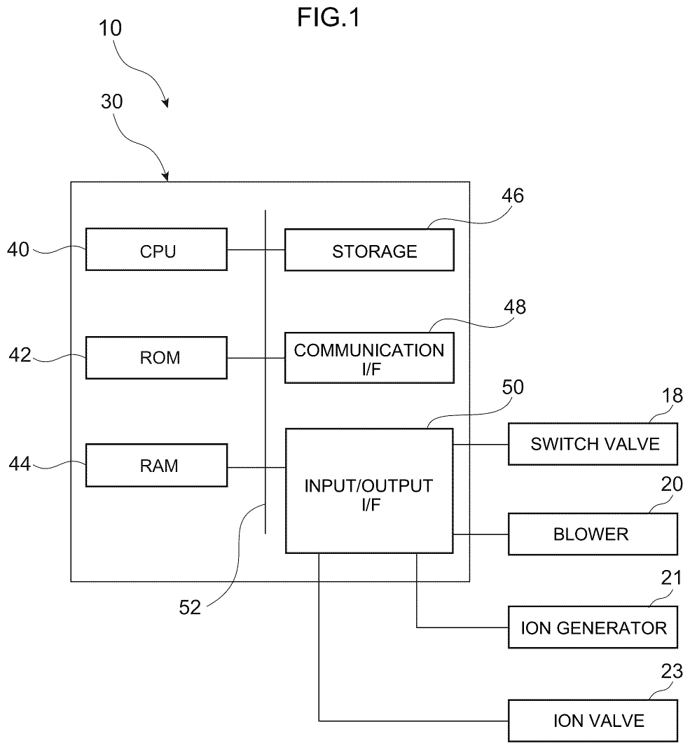

Explanation follows regarding a vehicle fragrance supply device 10 (hereafter simply referred to as the “fragrance supply device 10”) according to an exemplary embodiment, with reference to the drawings. FIG. 1 is a block diagram illustrating a hardware configuration of a fragrance supply device 10 according to an exemplary embodiment. The fragrance supply device 10 is installed in a vehicle, and is disposed, for example, inside an instrument panel provided at the front of the vehicle cabin, being a device that supplies fragrance into a vehicle cabin.

As illustrated in FIG. 1, the fragrance supply device 10 includes a control unit 30. The control unit 30 may be disposed in the vicinity of a fragrance supply unit that supplies the fragrance, or may be disposed at a position removed from the fragrance supply unit. The control unit 30 may be an electronic control unit (ECU) that controls the vehicle.

The control unit 30 is configured including a central processing unit (CPU: a processor) 40, read only memory (ROM) 42, random access memory (RAM) 44, storage 46, a communication interface (communication I/F) 48, and an input/output interface (input/output I/F) 50. These respective configurations are connected together through an internal bus 52 so as to be capable of communicating with each other.

The CPU 40 is a central processing unit that executes various programs and controls various units. Namely, the CPU 40 reads a program from the ROM 42 or the storage 46, and executes the program using the RAM 44 as a workspace. The CPU 40 controls the respective configurations and performs various computation processing according to a program recorded in the ROM 42 or the storage 46.

The ROM 42 stores various programs and various data. The RAM 44 serves as a workspace to temporarily store programs and data. The storage 46 is configured by a hard disk drive (HDD) or a solid state drive (SSD), and is a non-transitory recording medium that stores various programs including an operating system, as well as various data. In the present exemplary embodiment, a program or the like for performing various processing is stored in the ROM 42 or the storage 46.

The communication I/F 48 is a communication interface used by the fragrance supply device 10 to communicate with other devices and the like, and for example employs a protocol such as CAN (Controller Area Network), Ethernet (registered trademark), LTE (Long Term Evolution), FDDI (Fiber Distributed Data Interface), or Wi-Fi (registered trademark).

A switch valve 18, a blower 20 serving as a blowing device, an ion generator 21, and an ion valve 23 are connected to the input/output I/F 50. Details of the switch valve 18, the blower 20, the ion generator 21, and the ion valve 23 will be described later.

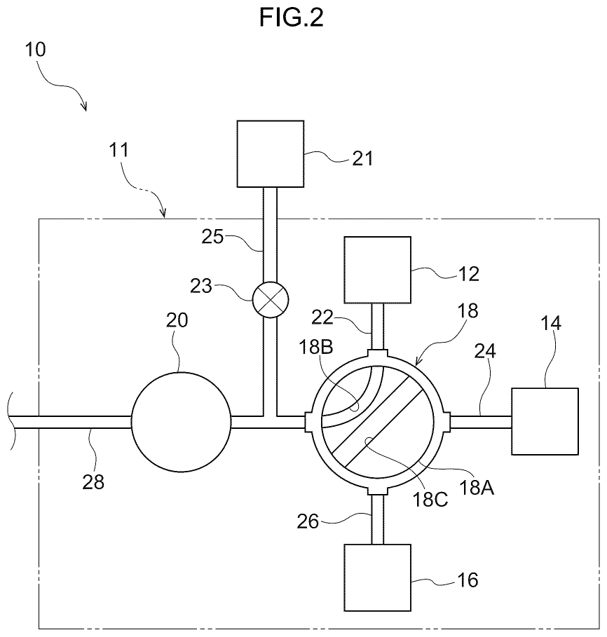

FIG. 2 is a schematic diagram of the fragrance supply device 10 according to the present exemplary embodiment. As illustrated in FIG. 2, the fragrance supply device 10 includes a fragrance supply unit 11. The fragrance supply unit 11 is mainly configured including a first fragrance generator 12, a second fragrance generator 14, a third fragrance generator 16, and a switch valve 18.

Although the present exemplary embodiment includes three fragrance generator, namely, the first fragrance generator 12, the second fragrance generator 14, and the third fragrance generator 16, as an example, there is no limitation thereto, and a structure including four or more fragrance generators may be employed. Alternatively, a structure including only one fragrance generator or a structure including two fragrance generators may be adopted. The first fragrance generator 12, the second fragrance generator 14, and the third fragrance generator 16 are configured so as to be capable of being loaded with a cartridge (not illustrated) containing an aromatic agent. This enables replenishment or replacement of the aromatic agent simply by replacing the cartridge.

One end of a first connecting pipe 22 is connected to the first fragrance generator 12, and the other end of the first connecting pipe 22 is connected to the switch valve 18. Namely, the first connecting pipe 22 connects the first fragrance generator 12 and the switch valve 18 together.

The second fragrance generator 14 is disposed at a position 90 degrees from the first fragrance generator 12 around the shaft of the switch valve 18. Note that there is no particular limitation on the positions of the first fragrance generator 12, the second fragrance generator 14, and the third fragrance generator 16.

One end of a second connecting pipe 24 is connected to the second fragrance generator 14, and the other end of the second connecting pipe 24 is connected to the switch valve 18. Namely, the second connecting pipe 24 connects the second fragrance generator 14 and the switch valve 18 together.

A third fragrance generator 16 is disposed at an opposite side from the first fragrance generator 12 with the switch valve 18 interposed therebetween. One end of a third connecting pipe 26 is connected to the third fragrance generator 16, and the other end of the third connecting pipe 26 is connected to the switch valve 18. Namely, the third fragrance generator 16 and the switch valve 18 are connected by the third connecting pipe 26.

The first connecting pipe 22, the second connecting pipe 24, the third connecting pipe 26, and a fragrance supply pipe 28 are connected to the switch valve 18. The fragrance supply pipe 28 is a pipe extending from the switch valve 18 toward the vehicle cabin, and the blower 20 is provided at the fragrance supply pipe 28. The fragrance supply pipe 28 is opened in the vicinity of a non-illustrated register provided in an instrument panel. As a result, by actuating the blower 20, air within the fragrance supply pipe 28 is supplied into the vehicle cabin. Namely, fragrance generated from the first fragrance generator 12, the second fragrance generator 14, and the third fragrance generator 16 is supplied into the vehicle cabin by flowing through the fragrance supply pipe 28.

The switch valve 18 is configured so as to be able to switch a communication state between each of the first fragrance generator 12, the second fragrance generator 14, and the third fragrance generator 16, and the fragrance supply pipe 28. More specifically, the switch valve 18 is provided with a rotary valve element 18A, and a first flow path 18B and a second flow path 18C are formed in the valve element 18A. Note that although the first flow path 18B is curved and the second flow path 18C is formed in a straight line in the present exemplary embodiment as an example, there is no limitation thereto, and the first flow path 18B and the second flow path 18C may be formed in other shapes. For example, the first flow path 18B and the second flow path 18C may be formed in a substantially straight line shape, and may be respectively formed at different positions in the depth direction of the valve element 18A. Further, three or more flow paths may be formed.

The valve element 18A is electrically connected to the control unit 30, and is rotated based on a signal from the control unit 30. For example, when handling a supply of fragrance as a result of an operation by an occupant of the vehicle, the control unit 30 causes the fragrance generator that generates the designated fragrance to be communicated with the fragrance supply pipe 28. In the present exemplary embodiment, when the valve element 18A of the switch valve 18 rotates, a fragrance generator that is one of the first fragrance generator 12, the second fragrance generator 14, or the third fragrance generator 16, is connected to the fragrance supply pipe 28.

FIG. 2 is a diagram illustrating a communication state in which the first fragrance generator 12 and the fragrance supply pipe 28 are communicated with each other. More specifically, one end of the first flow path 18B of the valve element 18A is connected to the first fragrance generator 12 via the first connecting pipe 22, and the other end of the first flow path 18B is connected to the fragrance supply pipe 28. Accordingly, when the blower 20 is actuated by the control unit 30 in the state illustrated in FIG. 2, the fragrance generated by the first fragrance generator 12 flows through the fragrance supply pipe 28 via the first flow path 18B, and is supplied into the vehicle cabin.

Moreover, in the state of FIG. 2, the second connecting pipe 24, to which the second fragrance generator 14 is connected, is closed by the valve element 18A. Further, the third connecting pipe 26, to which the third fragrance generator 16 is connected, is also closed by the valve element 18A. Accordingly, the fragrances generated by the second fragrance generator 14 and the third fragrance generator 16 are not supplied to the fragrance supply pipe 28.

When the valve element 18A is rotated clockwise from the state illustrated in FIG. 2, one end of the second flow path 18C of the valve element 18A is connected to the second fragrance generator 14 via the second connecting pipe 24, and the other end of the second flow path 18C is connected to the fragrance supply pipe 28. In this state, when the blower 20 is actuated, the fragrance generated by the second fragrance generator 14 flows through the fragrance supply pipe 28 via the second flow path 18C, and is supplied into the vehicle cabin.

On the other hand, when the valve element 18A is rotated counterclockwise from the state illustrated in FIG. 2, one end of the first flow path 18B of the valve element 18A is connected to the third fragrance generator 16 via the third connecting pipe 26, and the other end of the first flow path 18B is connected to the fragrance supply pipe 28. In this state, when the blower 20 is actuated, the fragrance generated by the third fragrance generator 16 flows through the fragrance supply pipe 28 via the first flow path 18B, and is supplied into the vehicle cabin.

An ion supply pipe 25 is connected to the fragrance supply pipe 28 of the present exemplary embodiment. More specifically, one end of the ion supply pipe 25 is connected to the ion generator 21, and the other end of the ion supply pipe 25 is connected to the fragrance supply pipe 28 between the switch valve 18 and the blower 20.

The ion generator 21 is a device that applies electricity to air to generate positive ions, negative ions, and the like, and generate ions that attach to surfaces of viruses and bacteria, for example, and inactivate the same. The ions generated from the ion generator 21 cause a chemical reaction with odor molecules and decompose the odor molecules.

The ion supply pipe 25 is provided with an ion valve 23. The ion valve 23 may be an electromagnetic valve that is opened and closed in response to a signal from the control unit 30. In the present exemplary embodiment, in a state in which any one of the first fragrance generator 12, the second fragrance generator 14, or the third fragrance generator 16, is communicated with the fragrance supply pipe 28, the ion valve 23 is configured to be maintained in a closed state.

Moreover, the control unit 30 is configured so as to control the switch valve 18 so that the first flow path 18B and the second flow path 18C are not communicated with any of the fragrance generators in a state in which the ion valve 23 is open.

When the blower 20 is actuated in a state in which the ion valve 23 open, the ions generated by the ion generator 21 flow through the fragrance supply pipe 28 via the ion supply pipe 25 and are supplied into the vehicle cabin.

### (Operation)

Next, explanation follows regarding the operation of the present exemplary embodiment.

According to the vehicle fragrance supply device 10 of the present exemplary embodiment, fragrance generated from any one of the first fragrance generator 12, the second fragrance generator 14, or the third fragrance generator 16 flows through the fragrance supply pipe 28 and is supplied into the vehicle cabin.

Moreover, the ion supply pipe 25, through which ions generated by the ion generator 21 flow, is connected to the fragrance supply pipe 28. As a result, by actuating the ion generator 21, ions flow into the fragrance supply pipe 28 via the ion supply pipe 25, and residual aroma remaining in the fragrance supply pipe 28 is removed.

Moreover, the ion supply pipe 25 is connected between the blower 20 and the switch valve 18 (fragrance generators) at the fragrance supply pipe 28. This enables the first fragrance generator 12, the second fragrance generator 14, the third fragrance generator 16, and the ion generator 21 to share the blower 20, which eliminates the need for a dedicated blowing device for supplying ions into the vehicle cabin.

Moreover, by controlling the switch valve 18, fragrance generated by any of the plural fragrance generators can be supplied into the vehicle cabin.

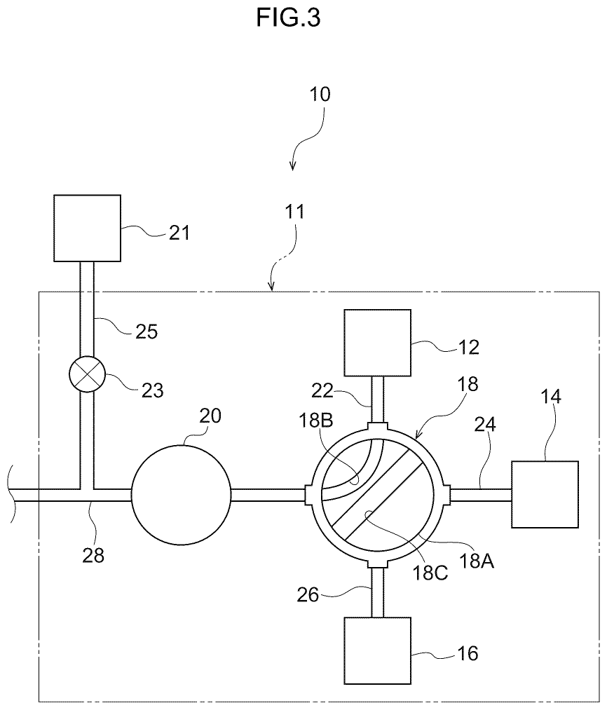

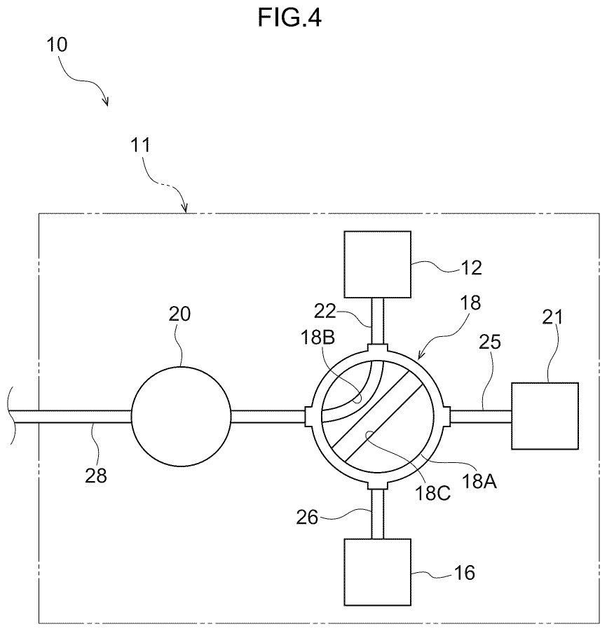

Although the ion supply pipe 25 is connected between the blower 20 and the switch valve 18 at the fragrance supply pipe 28 in the above exemplary embodiment, there is no limitation thereto, and the configurations of the first modified example illustrated in FIG. 3 and the second modified example illustrated in FIG. 4 may be adopted.

### First Modified Example

FIG. 3 is a schematic diagram of a fragrance supply device 10 according to a first modified example. As illustrated in FIG. 3, in the present modified example, the ion supply pipe 25 is connected downstream of the blower 20 at the fragrance supply pipe 28.

More specifically, the ion supply pipe 25 is connected to the fragrance supply pipe 28 on the opposite side of the blower 20 from the switch valve 18.

In the present modified example, the ion supply pipe 25 is connected to the fragrance supply pipe 28 downstream of the blower 20. This enables the ion generator 21 and the ion supply pipe 25 to be easily retrofitted to a vehicle not including an ion generator 21.

During maintenance of the ion generator 21 and the ion supply pipe 25, since there is no need to remove the blower 20, the switch valve 18, the first fragrance generator 12, the second fragrance generator 14, and the third fragrance generator 16, the ion supply pipe 25 can be easily accessed from the inside of the vehicle cabin, enabling workability to be improved.

### Second Modified Example

FIG. 4 is a schematic diagram of a fragrance supply device 10 according to a second modified example. As illustrated in FIG. 4, an ion generator 21 and an ion supply pipe 25 are provided instead of the second fragrance generator 14 and the second connecting pipe 24.

More specifically, the ion supply pipe 25 is directly connected to the switch valve 18. Moreover, the first connecting pipe 22 and the third connecting pipe 26 are connected to the switch valve 18. This enables switching to be performed by rotation of the valve element 18A of the switch valve 18 between a state in which the first connecting pipe 22 and the fragrance supply pipe 28 are communicated with each other, a state in which the third connecting pipe 26 and the fragrance supply pipe 28 are communicated with each other, and a state in which the ion supply pipe 25 and the fragrance supply pipe 28 are communicated with each other. Namely, the fragrance supply device 10 of the present modified example is configured so as to be switchable to a state in which the ion supply pipe 25 and the fragrance supply pipe 28 are communicated with each other by the switch valve 18.

As described above, in the present modified example, the switch valve 18 is controlled so as to enable ions to flow into the fragrance supply pipe 28. Moreover, by using the switch valve 18 in a similar manner to the switching between the first fragrance generator 12 and the third fragrance generator 16, since there is no need to provide a dedicated valve for the ion supply pipe 25, the number of components can be reduced.

Although explanation has been given regarding a vehicle fragrance supply device according to an exemplary embodiment and a modified example, needless to say, various embodiments may be implemented within a range not departing from the scope of the present disclosure. For example, in the exemplary embodiment described above, in a case in which an instruction to release a different fragrance has been received from an occupant, the valve element 18A is rotated to switch the communication state; however, at this time, ions generated by the ion generator 21 may be made to flow from the fragrance supply pipe 28 into the vehicle cabin. As a result, since aroma remaining in the fragrance supply pipe 28 is removed, mixing with other fragrances can be suppressed.

Although explanation has been given regarding a configuration including the blower 20 as a blowing device in the above exemplary embodiment, there is no limitation thereto, and a configuration not including the blower 20 may be adopted. In this case, fragrance may be supplied into the vehicle cabin using a blowing mechanism external to the fragrance supply device 10.

Moreover, although explanation has been given regarding a structure including the ion valve 23 in the above exemplary embodiments, as illustrated in FIG. 1 and FIG. 2, there is no limitation thereto. If control is performed so as to stop the ion generator 21 while fragrance is being supplied from the fragrance generator, the ion valve 23 is not required.

What is claimed is:

1. A vehicle fragrance supply device, comprising:
a fragrance generator configured to generate a fragrance;
a fragrance supply pipe configured to supply a generated scent from the fragrance generator to a vehicle cabin interior; and
an ion supply pipe connected to the fragrance supply pipe, through which ions generated at an ion generator flow.

2. The vehicle fragrance supply device of claim 1, wherein:
a blowing device is provided at the fragrance supply pipe, and
the ion supply pipe is connected to the fragrance supply pipe between the blowing device and the fragrance generator.

3. The vehicle fragrance supply device of claim 1, wherein:
a plurality of the fragrance generators are provided, and
the vehicle fragrance supply device further comprises a switch valve that is switchable between a state in which one of the fragrance generator is communicated with the fragrance supply pipe, and a state in which another of the fragrance generator is communicated with the fragrance supply pipe.

4. The vehicle fragrance supply device of claim 3, wherein:
the ion supply pipe is connected to the switch valve, and
the switch valve is switchable to a state in which the ion supply pipe is communicated with the fragrance supply pipe.

5. The vehicle fragrance supply device of claim 1, wherein:
a blowing device is provided at the fragrance supply pipe, and
the ion supply pipe is connected to the fragrance supply pipe at a downstream side of the blowing device.
